(19) United States
(12) Patent Application Publication
(10) Pub. No.: US 2024/0394521 A1
(43) Pub. Date: Nov. 28, 2024

(54) HARDWARE ENCODERS AND COMMUNICATION SYSTEMS FOR SPIKING NEURAL NETWORKS

(71) Applicant: University of Tennessee Research Foundation, Knoxville, TN (US)

(72) Inventors: Garrett Steven Rose, Knoxville, TN (US); Manu Rathore, Knoxville, TN (US); Sk Hasibul Alam, Knoxville, TN (US); Adam Z. Foshie, Knoxville, TN (US)

(21) Appl. No.: 18/675,826

(22) Filed: May 28, 2024

Related U.S. Application Data
(60) Provisional application No. 63/469,136, filed on May 26, 2023.

(51) Int. Cl. G06N 3/049

(52) U.S. Cl. CPC G06N 3/049

(57) ABSTRACT

Hardware encoders and communications networks for spiking neural networks (SNNs). In some examples, a hardware encoder is configured for encoding external data into spikes for spiking neural networks. The hardware encoder includes an input handler configured for managing input data using one or more registers and one or more counters; a spike generator configured for generating a spike-train using a look-up table (LUT) and the input data; and a neuron selector configured for routing the spike-train from the spike generator to a selected neuron or cluster of neurons. The hardware encoder can be configured for supported rate, temporal, and multi-spikes encoding. The hardware encoder can be configured for supporting different sizes for an encoding frame. The hardware encoder can be reconfigurable at runtime by virtue of the LUT.

### CROSS-REFERENCE TO RELATED APPLICATIONS

This application claims benefit of U.S. Provisional Application Ser. No. 63/469,136, filed on May 26, 2023, the disclosure of which is incorporated herein by reference in its entirety.

### GRANT STATEMENT

This invention was made with government support under Contract Number FA8750-21-1-1018 awarded by the Air Force Research Laboratory. The government has certain rights in the invention.

### BACKGROUND

Brain-inspired computation in the form of spiking neural networks (SNNs) is a growing field of research largely thanks to its promising potential in terms of power efficiency and usefulness in a variety of real-time applications. The way in which SNNs process data differs from traditional neural networks in that the data takes the form of a spike. These spikes have no value and instead rely on their spatio-temporal relation to one another to convey the information to be processed. Despite the emergence of a number of hardware-based neuroprocessors in the last decade, encoding external data into spikes has remained a primarily software-based endeavor. This means that the neuroprocessor still relies on some conventional processing to enable it to process data from peripheral sensors.

### SUMMARY

In some examples, a hardware encoder is configured for encoding external data into spikes for spiking neural networks. The hardware encoder includes an input handler configured for managing input data using one or more registers and one or more counters; a spike generator configured for generating a spike-train using a look-up table (LUT) and the input data; and a neuron selector configured for routing the spike-train from the spike generator to a selected neuron or cluster of neurons. The hardware encoder can be configured for supported rate, temporal, and multi-spikes encoding. The hardware encoder can be configured for supporting different sizes for an encoding frame. The hardware encoder can be reconfigurable at runtime by virtue of the LUT.

In some examples, a communication system is built using a hierarchical network-on-chip (NoC) architecture for globally sparse, locally dense communication systems. The communication system includes a circuit switching level; a bandwidth-focused topology; and a latency-focused topology. The circuit switching level can include a Clos network, the bandwidth-focused topology can include a mesh network, and the latency-focused topology can include a tree network. The communication system can be configured for establishing communication of spikes in a spiking neural network and the Clos network can be configured for supporting communication between neurons/nodes in the spiking neural network.

### BRIEF DESCRIPTION OF DRAWINGS

FIG. 1 is a block diagram of an example encoder module.

FIG. 2 shows a generic, overarching view of the hNoC architecture.

FIG. 3 illustrates an example hierarchical NoC structure split into three distinct levels.

FIG. 4 is a graph depicting the relationship between silicon area and cluster size for various Network-on-Chip (NoC) approaches.

### DETAILED DESCRIPTION

This document describes an encoder module that supports three major techniques—rate, temporal, and multi-spikes encoding. The module also supports three different sizes for the encoding frame. Both the encoding method and frame duration can be reconfigured at runtime with a maximum latency of five clock cycles. The smart use of look-up table (LUT) has made our hardware design highly scalable and fast, occupying minuscule area footprint.

This document also describes hierarchical network on chip architectures for globally sparse, locally dense communication systems. In large-scale computer architectures, no set solution for transferring data works for every communication system. There are, however, schemes where data transfers can be highly optimized for a particular class of communication system. One class of communication systems that is in need of optimization is globally sparse, locally dense systems in which the data being transferred is not particularly conducive to conversion into packets for one reason or another. To fill this need, this document describes the hNoC, a hierarchical network-on-chip (NoC) architecture for globally sparse, locally dense communication systems. The hNoC provides a trade-off between low power, high bandwidth, and low latency at different levels of a hierarchy where each metric matters most. At the same time, this network architecture retains the ability to be configurable from top to bottom.

### RHESp—A Runtime-Reconfigurable Hardware Encoder for Spiking Neural Networks

Brain-inspired computation in the form of spiking neural networks (SNNs) is a growing field of research largely thanks to its promising potential in terms of power efficiency and usefulness in a variety of real-time applications. The way in which SNNs process data differs from traditional neural networks in that the data takes the form of a spike. These spikes have no value and instead rely on their spatio-temporal relation to one another to convey the information to be processed. Despite the emergence of a number of hardware-based neuroprocessors in the last decade, encoding external data into spikes has remained a primarily software-based endeavor. This means that the neuroprocessor still relies on some conventional processing to enable it to process data from peripheral sensors.

The systems and methods described in this document can use an encoder module that supports three major techniques-rate, temporal, and multi-spikes encoding. The module also supports three different sizes for the encoding frame. Both the encoding method and frame duration can be reconfigured at runtime with a maximum latency of five clock cycles. The smart use of look-up table (LUT) has made our hardware design highly scalable and fast, occupying minuscule area footprint.

In some examples, the hardware spike encoder is configured to streamline the conversion of data gathered by sensors or real world interfaces into spikes that can be properly processed by spiking neural networks. The hardware module accelerates the spike encoding procedure by skipping any traditional CPU pre-processing entirely and routing the hardware encoded spikes into an SNN directly. By having a reconfigurable encoding method, the hardware encoder remains flexible in both its connections into an SNN and in its means of converting the data into a stream of spikes.

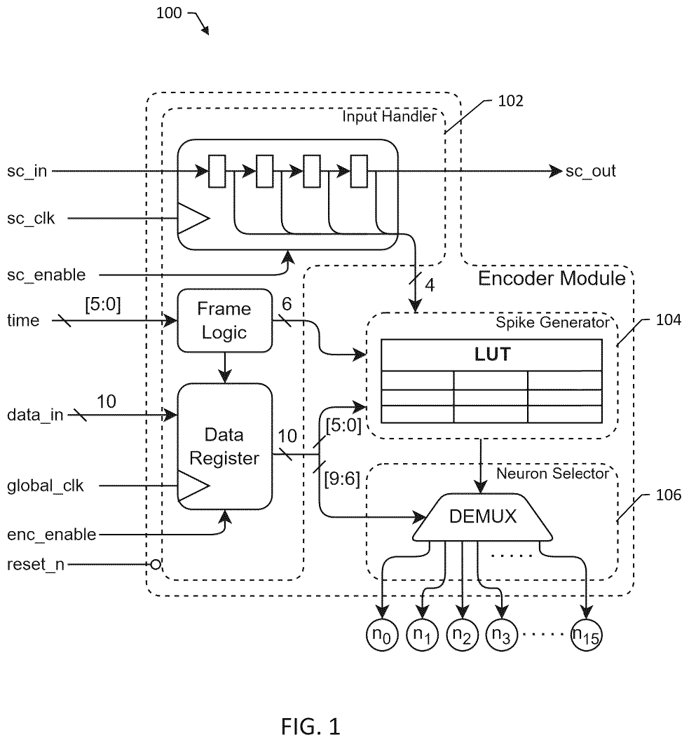

FIG. 1 is a block diagram of an example encoder module 100. The example hardware encoder has three major parts-input handler 102, spike generator 104, and neuron selector 106.

### Input Handler

The input handler 102 manages binary inputs using registers and counters. The input space can be divided into eight segments:
sc in: This is a one-time scan chain bitstream that is initially pushed into a system the encoder is part of. Four bits of this stream decide the encoding technique and encoding frame duration.
sc clk: This clock is associated with the scan chain which determines how fast the scan chain moves through the system.
sc enable: This determines when to stop the scan chain. This pin is initially asserted high to move the scan chain through the system. As soon as it is asserted low, the stream of sc_in stops.
time: This is the timing signal that counts from 0 to a high value integer. A frame logic block detects the change in time-steps, and consequently the beginning of an encoding frame.
data in: This signal contains the value to be translated into a spike-train, and the destination address of that spike-train. This input may change very often but is registered only at the beginning of each encoding frame.
global clk: This is the fastest clock signal which controls every register except those used for the scan chain.
enc enable: This determines when to start or stop the encoding process. This pin is initially asserted low as long as the scan chain is moving. It can be asserted high as soon as that sc_enable goes low.
reset n: This is a synchronous, active-low signal that resets all registered signals inside the encoder module to their respective initial values.

### Spike Generator

The spike generator 104 generates the spike-train using an LUT. The LUT takes three different sets of inputs to build the train. When it obtains new inputs, the appropriate voltage is available on its output.
Value: It comes from part of the data register. This is the value that is to be translated into spike-train. The range of this value is strictly equal to the duration of encoding frame.
Scheme: It comes from the shift register of scan chain that selects one of the three encoding schemes to be used.
Timing: It comes from the frame logic block. This decides whether the current time-step is appropriate for a spike or not.

### Neuron Selector

The neuron selector 106 is a 4-to-16 demultiplexer. The spike-train from the spike generator 104 goes to one of the sixteen different neurons, or clusters of neurons, using the destination address from the data register.

By running the spike encoder continuously, data can also be encoded in real time as the sensors collect data without requiring the neural network to be interrupted while data is first encoded by a CPU then transferred into the network as a packet. Thanks to the reconfigurable nature of the encoder, it is also possible that multiple sensors could be connected to the encoder in a time-multiplexed fashion with different encoding types and/or destination neurons specified per sensor.

hNoC: The Hierarchical Network on Chip Architecture for Globally Sparse, Locally Dense Communication Systems

In large-scale computer architectures, no set solution for transferring data works for every communication system. There are, however, schemes where data transfers can be highly optimized for a particular class of communication system. One class of communication systems that is in need of optimization is globally sparse, locally dense systems in which the data being transferred is not particularly conducive to conversion into packets for one reason or another.

The hNoC, a hierarchical network-on-chip (NoC) architecture for globally sparse, locally dense communication systems, can fulfill this need. The hNoC provides a trade-off between low power, high bandwidth, and low latency at different levels of a hierarchy where each metric matters most. At the same time, this network architecture retains the ability to be configurable from top to bottom.

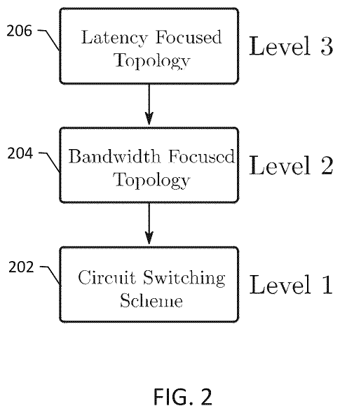

FIG. 2 shows a generic, overarching view of the hNoC architecture. The hierarchy is split into three distinct levels with each level handling the communication of data in a different way. Starting at the lowest level 202 of the hierarchy, it is assumed that the communication system in which the hNoC is applied fundamentally transfers data that is not conducive to conversion into packets. This means that it is rather inefficient to perform that conversion, detrimental to the integrity of the data to convert it, or both. With that being the case, the lowest level 202 of the hierarchy is implemented with a circuit switching scheme which directs original data from one node to another via programmable switches. This scheme can be modeled after telecommunication network inspired topologies like Clos/Benes networks. These networks allow the communication of data to remain non-blocking.

Keeping a network of nodes connected using a circuit switching scheme is only feasible up to a certain size of network due to the rapid growth of resources required per additional node. Because of this, there will be a point where it becomes more beneficial to accept the penalty of converting the data into a packetized format in which it can be transferred using a shared routing topology. This is where the second level 204 of the hierarchy comes into play. It is assumed that the communication system in which the hNoC is applied experiences more dense communications at a local level. Dense communication requires an increased bandwidth to handle the expected traffic. To this end, the second level 204 of the hNoC hierarchy is a bandwidth focused, packet transferring network. This topology will sacrifice the power efficiency/data integrity benefits of circuit switching schemes but greatly improves the scalability of the NoC.

For a communication system suitable for the hNoC, the level 2 network operates great for dense communications at a local level. However, once the level 2 network reaches a certain size, the distance between nodes becomes great enough that data will rarely transfer between them. It is at this stage that the third level 206 of the hierarchy is introduced. Once communications over a longer distance become sparse, it becomes important to prioritize the latency of those sparse data transfers rather than the bandwidth capability of the network. For this reason, the third level 206 of the hierarchy is implemented as a latency focused network topology that interconnects level 2 networks.

When combined into a three layer hierarchical structure, the hNoC brings about a NoC architecture that prioritizes data in its most efficient and accurate form at the lowest level, bandwidth at the in-between level, and low-latency, at the highest, most physically distant level.

In some examples, the network architecture is configured for establishing communication of spikes in a SNN.

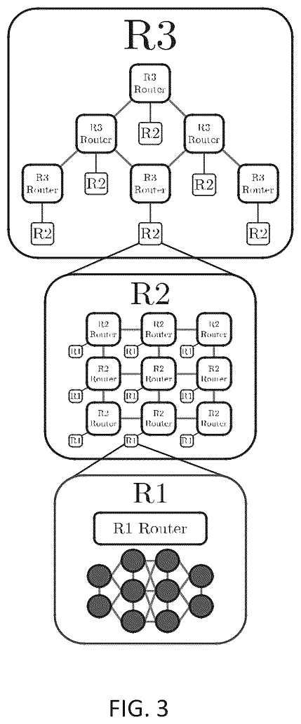

FIG. 3 illustrates an example hierarchical NoC structure split into three distinct levels: R1, R2, and R3. The R1 level includes a cluster of neurons or neural cores connected in a non-blocking fashion in which communications remain as pure spikes and favors power efficiency. The R1 router converts between spikes and packets for communication coming into or going out of the R1 level. The R2 level consists of numerous clusters connected to each other in a mesh topology by directing AER packets between R2 routers. This creates a larger network called a neural array. The mesh topology favors bandwidth over communication latency which is useful for route flexibility between physically close connections. Finally, the R3 level connects neural arrays together in a tree topology that favors minimal communication latency over network bandwidth.

FIG. 3 shows an example network architecture for the SNN that employs a Clos network at level 1 (R1), a mesh network topology at Level 2 (R2), and a tree network topology at level 3 (R3). R1 supports communication between the neurons/nodes in relatively denser clusters at the lowest level. These clusters are groups of neurons that communicate spike data directly. This approach obviates the need for spike to packet conversion for communication between neurons closely packed in space and time.

Table 1 and Table 2 show comparison of delay and power efficiency between a Clos network neuron cluster and neuron array communicating using packetized Address Event Representation (AER) scheme.

TABLE 1
Latency and throughput comparison for different sized clusters

| | R1-level Circuit- | | Traditional Packet-based | | | |
|---|---|---|---|---|---|---|
| | Switching Network | | Mesh AER | | | |
| Cluster | Average | | Worst Case | Worst Case | Best Case | Best Case |
| size (no. of | latency | Throughput | Latency | Throughput | Latency | Throughput |
| neurons) | (ps) | (spikes/s) | (μs) | (spikes/s) | (μs) | (spikes/s) |
| 4 | 104 ps | 9.6 × 10⁹ | 16 | 1.43 × 10⁵ | 9 | 1.43 × 10⁵ |
| 16 | 593 ps | 1.68 × 10⁹ | 44 | 1.43 × 10⁵ | 9 | 1.43 × 10⁵ |
| 64 | 725 ps | 1.3 × 10⁹ | 100 | 1.43 × 10⁵ | 9 | 1.43 × 10⁵ |
| 256 | 961 ps | 1.04 × 10⁹ | 212 | 1.43 × 10⁵ | 9 | 1.43 × 10⁵ |

TABLE 2
Energy/Power consumption per spike transmission

| | R1- | Traditional | Traditional |
|---|---|---|---|
| | level Circuit- | Mesh AER | Mesh AER |
| Cluster | Switching | (Worst | (Best |
| size | Network | Case) | Case) |
| 4 | 0.296 pJ | 107.1 pJ | 60.2 pJ |
| 16 | 1.4 pJ | 295.4 pJ | 60.2 pJ |
| 64 | 8.51 pJ | 670.6 pJ | 60.2 pJ |
| 256 | 36.1 pJ | 1423.8 pJ | 60.2 pJ |

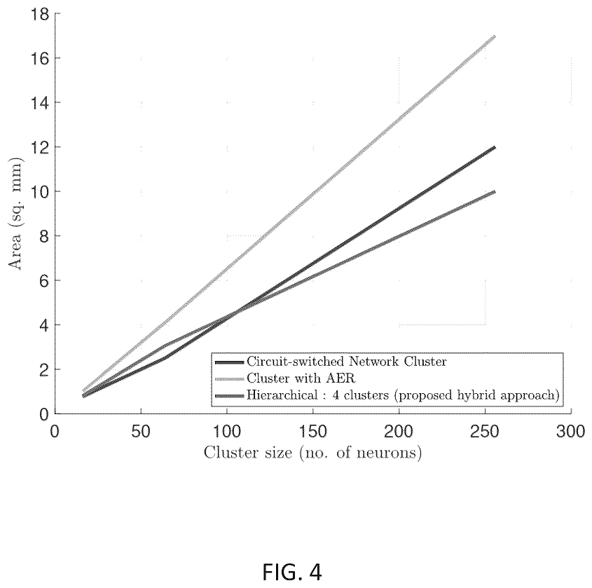

FIG. 4 is a graph depicting the relationship between silicon area and cluster size for various Network-on-Chip (NoC) approaches. The hierarchical approach illustrated in this graph represents data for the lower two levels of proposed architecture; comprising circuit-switched R1 level and AER packetized R2 level networks.

FIG. 4 shows how the area scales as the cluster size grows (65 nm technology). It is clear that for smaller cluster sizes Clos circuit switching scheme outperforms AER in all metrics. However, as the size of the network grows, the interconnect length and switch size required to implement the Clos scheme grow much faster than AER.

Since AER is more scalable, we switch to packetized AER communication at Level R2 and Level R3. R2 organizes neuron clusters in a mesh architecture called a Neural Array (NA). The mesh network directs packets in cardinal directions and favors bandwidth at the cost of latency. That means that this level can handle a larger amount of data than other network topologies, but the data is in transit for longer on average. This trade-off is considered favorable because the physical distance that signals need to travel at this level is still rather low, and depending on the number of clusters in the network, the number of packet transfers between them may warrant the extra bandwidth.

As the network/SNN size grows, the top-level tree configuration, R3, is used for connecting NAs; this optimizes for area and latency. Tree topologies inherently allow packets to travel through the network with fewer hops required to reach their destination, but suffer more limitations with network congestion since routes tend to converge when going to the same destination.

This network architecture ensures the local communication within the cluster are simple, efficient, spikes. We expect the long-distance connectivity within the entire network to get sparser as we move up the hierarchy from level 1 to level 3, and thus majority of the communication traffic is located at the lowest level, R1.

In some examples, the network can be employed for analog neural networks that communicate using current flow or voltage values from one node to another. The lowest level network is a crossbar that connects analog output from one node directly to input of another node. This avoids the need for the bulky Analog-to-Digital (ADC) and Digital-to-Analog (DAC) conversion for closely-packed nodes. This not only saves resources in terms of area and energy consumption but also retains the precision of the data that is otherwise lost during conversion. For communications outside the cluster, we use these ADCs and DACs to establish packetized AER communication via Level 2 and Level 3 of the network hierarchy. Level 2 in this case is a spline architecture and Level 3 is a hub and spoke network topology.

Following long-standing patent law convention, the terms “a”, “an”, and “the” refer to “one or more” when used in this application, including the claims. Thus, for example, reference to “a component” includes a plurality of such components, and so forth.

Unless otherwise indicated, all numbers expressing quantities of ingredients, reaction conditions, and so forth used in the specification and claims are to be understood as being modified in all instances by the term “about”. Accordingly, unless indicated to the contrary, the numerical parameters set forth in this specification and attached claims are approximations that can vary depending upon the desired properties sought to be obtained by the presently disclosed subject matter.

As used herein, the term “about,” when referring to a value or to an amount of a composition, mass, weight, temperature, time, volume, concentration, percentage, etc., is meant to encompass variations of in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods or employ the disclosed compositions.

As used herein, ranges can be expressed as from “about” one particular value, and/or to “about” another particular value. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the term “and/or” when used in the context of a listing of entities, refers to the entities being present singly or in combination. Thus, for example, the phrase “A, B, C, and/or D” includes A, B, C, and D individually, but also includes any and all combinations and subcombinations of A, B, C and D.

It will be understood that various details of the presently disclosed subject matter can be changed without departing from the scope of the presently disclosed subject matter. Furthermore, the foregoing description is for the purpose of illustration only, and not for the purpose of limitation.

The control systems and computer systems described herein may be implemented in hardware, software, firmware, or any combination thereof. In some exemplary implementations, the subject matter described herein may be implemented using a computer readable medium having stored thereon computer executable instructions that when executed by the processor of a computer control the computer to perform steps.

Exemplary computer readable media suitable for implementing the subject matter described herein include non-transitory computer readable media, such as disk memory devices, chip memory devices, programmable logic devices, and application specific integrated circuits. In addition, a computer readable medium that implements the subject matter described herein may be located on a single device or computing platform or may be distributed across multiple devices or computing platforms.

What is claimed is:

1. A hardware encoder configured for encoding external data into spikes for spiking neural networks, the hardware encoder comprising:
an input handler configured for managing input data using one or more registers and one or more counters;
a spike generator configured for generating a spike-train using a look-up table (LUT) and the input data; and
a neuron selector configured for routing the spike-train from the spike generator to a selected neuron or cluster of neurons.

2. The hardware encoder of claim 1, wherein the hardware encoder is configured for supported rate, temporal, and multi-spikes encoding.

3. The hardware encoder of claim 1, wherein the hardware encoder is configured for supporting different sizes for an encoding frame.

4. The hardware encoder of claim 1, wherein the hardware encoder is reconfigurable at runtime by virtue of the LUT.

5. A communication system built using a hierarchical network-on-chip (NoC) architecture for globally sparse, locally dense communication systems, the communication system comprising:
a circuit switching level;
a bandwidth-focused topology; and
a latency-focused topology.

6. The communication system of claim 5, wherein the circuit switching level is implemented as a multistage network topology, the bandwidth-focused topology comprises a mesh network, and the latency-focused topology comprises a tree network.

7. The communication system of claim 6, wherein the communication system is configured for establishing communication of spikes in a spiking neural network and the circuit switching level is configured for supporting communication between neurons/nodes in the spiking neural network.

8. The communication system of claim 7, wherein the circuit switching level is configured for communicating using packetized address event representation.

9. A method for encoding external data into spikes for spiking neural networks, the method comprising:
managing, by an input handler, data using one or more registers and one or more counters;
generating, by a spike generator, a spike-train using a look-up table (LUT) and the input data; and
routing, using a neuron selector, the spike-train from the spike generator to a selected neuron or cluster of neurons.

10. The method of claim 9, comprising performing supported rate, temporal, and multi-spikes encoding.

11. The method of claim 9, comprising supporting different sizes for an encoding frame.

12. The method of claim 9, comprising reconfiguring the input handler, spike generator, and/or neuron selector at runtime by virtue of the LUT.

13. The method of claim 9, comprising communicating using communication system built using a hierarchical network-on-chip (NoC) architecture for globally sparse, locally dense communication systems, the communication system comprising a circuit switching level, a bandwidth-focused topology, and a latency-focused topology.

14. The method of claim 9, wherein the circuit switching level is implemented as a multistage network topology, the bandwidth-focused topology comprises a mesh network, and the latency-focused topology comprises a tree network.

15. The method of claim 14, wherein the communication system is configured for establishing communication of spikes in a spiking neural network and the circuit switching level is configured for supporting communication between neurons/nodes in the spiking neural network.
